(19) United States
(12) Patent Application Publication
(10) Pub. No.: US 2012/0296005 A1
(43) Pub. Date: Nov. 22, 2012

(54) MEDICAL RESIN COMPOSITION, MANUFACTURING PROCESS THEREFOR AND MEDICAL KIT

(75) Inventor: Jiro Tanaka, Okayama-shi (JP)

(73) Assignee: NATIONAL UNIVERSITY CORPORATION OKAYAMA UNIVERSITY, Okayama-shi (JP)

(21) Appl. No.: 13/574,216

(22) PCT Filed: Jan. 19, 2011
(86) PCT No.: PCT/JP2011/050880

§ 371 Date: Jul. 19, 2012

(30) Foreign Application Priority Data
Jan. 20, 2010 (JP) 2010-010216

(51) Int. Cl. C08L 33/12; C09J 133/12

(52) U.S. Cl. 523/116; 525/305; 525/226

(57) ABSTRACT

A medical resin composition, particularly a dental resin composition is produced by mixing a polymer (A) containing 70% by weight or more of methyl methacrylate units and a liquid of a monomer (B) containing 70% by weight or more of a compound (b1) represented by formula (1):

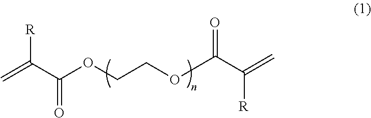

wherein R denotes a methyl group or a hydrogen atom and n is an integer of 2 to 4, in the presence of a polymerization initiator (C) to increase a viscosity. The resin composition can be suitably used in producing a denture base, a mouthpiece or a bone cement. A shaped article formed using such a resin composition exhibits excellent mechanical properties, particularly toughness. Furthermore, such a resin composition can be prepared with ease.

### TECHNICAL FIELD

The present invention relates to a medical resin composition containing a polymer containing methyl methacrylate units, a monomer containing polyethylene glycol di(meth)acrylate and a polymerization initiator, particularly a dental resin composition. This invention also relates to a process for manufacturing such a medical resin composition. Furthermore, the invention relates to a denture base or mouthpiece comprising a dental resin composition, a bone cement consisting of a medical resin composition and a medical kit containing a medical resin composition.

### BACKGROUND ART

In the field of medicine, resin compositions are frequently used because of convenient operation and easier acquisition of aesthetic appearance. For example, in the field of dentistry, thermoplastic and thermosetting resins are used in tissue conditioners, functional impression materials, relining materials, denture base materials or mouthpiece materials, and, in the field of orthopedics, in bone cement materials. However, mechanical properties of a shaped article made of a resin composition is generally inferior to those of a metal or ceramic material, and, therefore, improvement in such a shaped article has been needed in many applications.

A denture base plays a role in stably holding dentures in oral cavity. Denture base materials known in the art include metal materials such as cobalt-chromium alloys and gold alloys and resin compositions such as polymethyl methacrylate; particularly, resin compositions are frequently used in the light of convenient operation and aesthetic appearance. A denture is used for several to several ten years. After long-term use in oral cavity, a denture may be broken due to occlusal pressure and occlusal wear of artificial teeth and/or ridge resorption may lead to occlusal imbalance and poorly-fitting denture base. A resin composition for a denture base must, therefore, show mechanical properties tolerant to such long-term use and easiness in processing or modification. A known example of a resin composition generally used for a denture base is a composition consisting of a powder of polymethyl methacrylate (PMMA) and a liquid of methyl methacrylate (MMA). Such a resin composition is characterized in that in its use, the liquid and the powder are blended and allowed to stand until the powder is swollen and dissolved to form a dough, which is then shaped by, for example, packing into a negative mold and then polymerized to provide a product with a desired shape. However, in the prior art, methyl methacrylate can be used as a monomer component to endow a product with strength and hardness to some degree, but the product is so brittle that it cannot substantially absorb a force or impact applied to a denture base, leading to insufficient mechanical strength such as breakage due to occlusal pressure in use and breakage by drop impact. Furthermore, methyl methacrylate which is volatile may degrade operability and deteriorate working conditions due to odor or cause entrainment of bubbles, which leads to formation of fine irregularities in the denture surface after curing which cause stain or discoloration of a denture after long-term use.

Patent Reference 1 has described a denture base material comprising a monofunctional (meth)acrylate as a resin matrix monomer, at least a polymethyl methacrylate as a powdery polymer and an ambient-temperature polymerization initiator, wherein the polymethyl methacrylate has a molecular weight of 60,000 to 100,000 and an average particle size of 30 to 50 μm. The reference describes that the material further contains a multifunctional acrylate as a crosslinking agent including, among those listed as examples, polyethylene glycol dimethacrylate. It is described that polymerization at an ambient temperature to 55° C. can provide highly fitting denture base which can be produced without being heated, resulting in excellent operability. It is, however, described that a suitable monofunctional (meth)acrylate is methyl methacrylate which causes degradation of a working environment and insufficient toughness.

Patent Reference 2 has described a resin material for a denture base as a mixture of a polymerizable monomer having an unsaturated double bond, a polyalkyl (meth)acrylate and a polymerization catalyst, wherein at least some of the polyalkyl (meth)acrylate is dissolved in the polymerizable monomer. It is described that the material pre-prepared as a paste can simplify operation and give a cured product with a large elastic energy as well as proper hardness and toughness. In the section of Examples, there is described a resin material for a denture base consisting of 40 parts by weight of ethylene glycol dimethacrylate, 60 parts by weight of a methyl methacrylate-styrene copolymer, 0.4 parts by weight of a polymerization catalyst and 5 parts by weight of a filler. The resin material, however, provided a cured product with an insufficient toughness.

Patent Reference 3 has described a lining material for a denture base consisting of a monomer component and a polymer component, wherein the monomer component comprises 60% by weight or more of ethylene glycol dimethacrylate. It is also described that, for example, 40% by weight or less of triethylene glycol dimethacrylate can be contained as a monomer component, and the section of Examples describes a lining material for a denture base comprising of a mixture of ethylene glycol dimethacrylate and triethylene glycol dimethacrylate as a monomer component and polyethyl methacrylate as a polymer material. The lining material for a denture base, however, has a low elastic modulus and insufficient toughness.

### PRIOR ART REFERENCES

### Patent References

Patent Reference 1: JP 2007-332044
Patent Reference 2: JP 2000-254152
Patent Reference 3: JP 1996-48609

### SUMMARY OF THE INVENTION

### Problem to be Solved by the Invention

To solve the above problems, an objective of the present invention is to provide a medical resin composition, particularly a dental resin composition which can provide a shaped article exhibiting high strength, a high elastic modulus and excellent toughness. Another objective of the invention is to provide a method for preparing such a resin composition in good operability.

### Means for Solving the Problems

The above problems can be solved by providing a medical resin composition comprising a polymer (A), a monomer (B) and a polymerization initiator (C), wherein the polymer (A) comprises 70% by weight or more of methyl methacrylate units, and the monomer (B) comprises 70% by weight or more of a compound (b1) represented by formula (1):

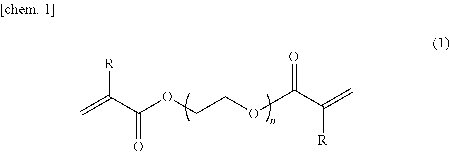

wherein R denotes a methyl group or a hydrogen atom and n is an integer of 2 to 4.

It is suitable that the composition contains 30 to 100 parts by weight of the monomer (B) based on 100 parts by weight of the polymer (A).

A suitable embodiment of the present invention is a dental resin composition consisting of the medical resin composition. Specifically, a suitable embodiment is a denture base or mouthpiece produced by curing a dental resin composition. A bone cement consisting of the medical resin composition is also a suitable embodiment of the present invention.

It is suitable to provide a process for manufacturing the above medical resin composition, wherein a powder of the polymer (A) and a liquid of the monomer (B) are mixed in the presence of the polymerization initiator (C) to increase a viscosity. It is suitable that the polymer (A) preliminarily contains the polymerization initiator (C).

The above problems can be also solved by providing a medical kit comprising a powder of a polymer (A) comprising 70% by weight or more of methyl methacrylate units; and a liquid of a monomer (B) comprising 70% by weight or more of compound (b1) represented by formula (1):

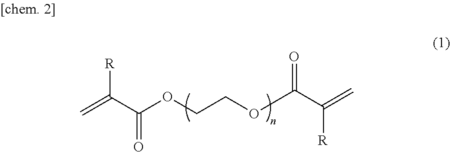

wherein R denotes a methyl group or a hydrogen atom, and n is an integer of 2 to 4, wherein

at least one of the powder and the liquid comprises a polymerization initiator (C).

### Effects of the Invention

A shaped article produced by curing a resin composition of the present invention exhibits high strength, a high elastic modulus and excellent toughness. The resin composition is, therefore, suitably used for producing, for example, a denture base or mouthpiece. Furthermore, according to a manufacturing process of the invention, the resin composition can be prepared in good operability. Furthermore, a medical kit of the present invention can be used to conveniently produce the resin composition.

### BRIEF DESCRIPTION OF THE DRAWINGS

FIG. 1 is a graph plotting a flexural modulus (GPa) (vertical axis) to the number of ethylene glycol monomer units (n) (horizontal axis) for test pieces prepared in Examples 1 to 3 and Comparative Example 1.

FIG. 2 is a graph plotting a flexural strength (MPa) (vertical axis) to the number of ethylene glycol monomer units (n) (horizontal axis) for test pieces prepared in Examples 1 to 3 and Comparative Example 1.

FIG. 3 is a graph plotting a maximum deflection (mm) (vertical axis) to the number of ethylene glycol monomer units (n) (horizontal axis) for test pieces prepared in Examples 1 to 3 and Comparative Example 1.

FIG. 4 is a graph plotting a fracture energy (KJ/m²) (vertical axis) to the number of ethylene glycol monomer units (n) (horizontal axis) for test pieces prepared in Examples 1 to 3 and Comparative Example 1.

FIG. 5 is a graph plotting a flexural modulus (GPa) (vertical axis) to a powder-liquid ratio (g/mL) (horizontal axis) for Example 5.

FIG. 6 is a graph plotting a flexural strength (MPa) (vertical axis) to a powder-liquid ratio (g/mL) (horizontal axis) for Example 5.

FIG. 7 is a graph plotting a maximum deflection (mm) (vertical axis) to a powder-liquid ratio (g/mL) (horizontal axis) for Example 5.

FIG. 8 is a graph plotting a fracture energy (KJ/m²) (vertical axis) to a powder-liquid ratio (g/mL) (horizontal axis) for Example 5.

FIG. 9 shows a microscopic image of a thin section of a shaped article produced at a powder-liquid ratio of 1.2 (g/mL) for Example 6.

FIG. 10 shows a microscopic image of a thin section of a shaped article produced at a powder-liquid ratio of 1.4 (g/mL) for Example 6.

FIG. 11 shows a microscopic image of a thin section of a shaped article produced at a powder-liquid ratio of 1.6 (g/mL) for Example 6.

FIG. 12 shows a microscopic image of a thin section of a shaped article produced at a powder-liquid ratio of 1.8 (g/mL) for Example 6.

FIG. 13 shows a microscopic image of a thin section of a shaped article produced at a powder-liquid ratio of 2.0 (g/mL) for Example 6.

FIG. 14 shows a microscopic image of a thin section of a shaped article produced at a powder-liquid ratio of 2.2 (g/mL) for Example 6.

FIG. 15 shows a microscopic image of a thin section of a shaped article produced at a powder-liquid ratio of 2.4 (g/mL) for Example 6.

### MODE FOR CARRYING OUT THE INVENTION

A medical resin composition of the present invention is a medical resin composition comprising a polymer (A), a monomer (B) and a polymerization initiator (C), wherein

the polymer (A) comprises 70% by weight or more of methyl methacrylate units, and

the monomer (B) comprises 70% by weight or more of a compound (b1) represented by formula (1):

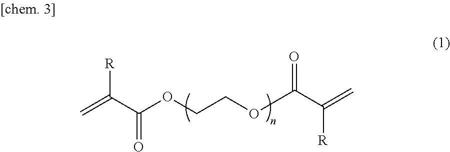

wherein R denotes a methyl group or a hydrogen atom and n is an integer of 2 to 4.

A resin composition of the present invention is preferably prepared by, but not limited to, mixing a powder of a polymer (A) and a liquid of a monomer (B). The polymerization initiator (C) can be preliminarily contained in at least one of the powder or the liquid, or added during preparation of the resin composition. Once the powder and the liquid are mixed, the powder is swollen with the liquid, then, the mixture changes from a highly viscous liquid to dough form. Although a resin composition even as a highly viscous liquid can be shaped on a model when the resin composition is used for a material for a denture base, it is generally preferable that a resin composition as a dough is shaped into a desired form by, for example, packing into a negative mold. Thus, it is preferable to keep the resin composition in a dough state during shaping the resin composition. After shaping the resin composition, the monomer (B) in the resin composition can be polymerized to provide a cured shaped article.

Conventionally, methyl methacrylate has been extensively used as a monomer for a polymerization reaction in a resin composition such as a medical resin composition, particularly a dental resin composition. It is mainly because methyl methacrylate can swell polymethyl methacrylate generally used as a powder in a short time and it exhibits good polymerizability. It has a feature that it provides a resin composition with less unreacted residual monomers after polymerization. Due to its good swellability, the resin composition can generally keep a dough state only for about 5 minutes, so that a sufficient time is not ensured for shaping. Furthermore, there have been problems such as heat of reaction or shrinkage during polymerization and insufficient mechanical strength when it is used as a material for a denture base. In particular, its inadequate toughness and brittleness have led to breakage of a denture base by an occlusal pressure during the use of a denture, damage by dropping and the like. On the other hand, when a polyethyl methacrylate or a copolymer of ethyl methacrylate and methyl methacrylate which has a lower glass-transition temperature and tends to swell is used as a powder, its elastic modulus or strength becomes inadequate.

In contrast, a resin composition of the present invention contains, as the most prominent feature, the monomer (B) containing the compound (b1) represented by formula (1) in 70% by weight or more as a monomer to be mixed with the polymer (A). The compound (b1) is a crosslinkable monomer having a methacryloyl or acryloyl group as a polymerizable group in both ends of a polyethylene glycol unit, which allows for sufficient swelling of the polymer (A) at a proper rate and for ensuring an adequate time for keeping a dough state during processing such as shaping. Furthermore, by the use of the monomer (B) allows for easily providing a shaped article after polymerization, which has high strength and a high elastic modulus while having excellent toughness.

First, there will be described the polymer (A). The polymer (A) is a polymer containing methyl methacrylate units in 70% by weight or more. Methyl methacrylate units contained in 70% by weight or more can provide a shaped article with high strength and a high elastic modulus. Thus, such a shaped article can be suitably used as a material for a denture base or the like which is required to have strength and an elastic modulus at a predetermined level. Polymethyl methacrylate is suitably used as a material for medical use, and the polymer (A) containing methyl methacrylate units in 70% by weight or more is expected to be highly biocompatible. Furthermore, the polymer (A) is an amorphous polymer with a relatively higher glass-transition temperature, which can easily provide a powder having a particle size suitable for embodying the present invention by, for example, suspension polymerization. The polymer (A) can be a homopolymer of methyl methacrylate or a copolymer of methyl methacrylate with another monomer. The content of methyl methacrylate units in the polymer (A) is suitably 80% by weight or more, more suitably 90% by weight or more, further suitably 95% by weight or more. If the content of methyl methacrylate units is less than 70% by weight, a shaped article produced has reduced strength and a smaller elastic modulus.

When the polymer (A) is a copolymer, there are no particular restrictions to a monomer to be copolymerized with methyl methacrylate as long as the monomer is copolymerizable with methyl methacrylate. Examples include alkyl (meth)acrylates such as methyl acrylate, ethyl (meth)acrylate, isopropyl (meth)acrylate, n-propyl (meth)acrylate, n-butyl (meth)acrylate, isobutyl (meth)acrylate or t-butyl (meth)acrylate; olefins such as ethylene and propylene; vinyl carboxylates such as vinyl acetate; maleic anhydride; acrylonitrile; styrene; and vinyl chloride. These monomers can be used alone or in combination of two or more. In the light of swellability of a polymer, ethyl methacrylate is suitable. The content of such a monomer is generally 30% by weight or less, suitably 20% by weight or less, more suitably 10% by weight or less, further suitably 5% by weight or less.

In terms of a molecular weight, the polymer (A) generally has, but not limited to, a weight-average molecular weight of 5,000 to 2,000,000. If the molecular weight is lower than 5,000, a shaped article obtained may have insufficient strength. The molecular weight is more suitably 200,000 or more, further suitably 300,000 or more. A molecular weight of the polymer (A) is more suitably 1,500,000 or less, further suitably 1,000,000 or less. The above weight-average molecular weight can be determined by gel permeation chromatography (GPC).

The monomer (B) contained in a resin composition of the present invention contains the compound (b1) represented by formula (1) in 70% by weight or more. The compound (b1) represented by formula (1) is a crosslinkable monomer in which both ends of the polyethylene glycol unit (n in the formula is 2 to 4) have a methacryloyl group (R is a methyl group in the formula) or an acryloyl group (R is a hydrogen atom in the formula) which is a polymerizable group. The use of such a monomer allows for endowing a shaped article formed by polymerizing the resin composition with excellent toughness. Generally, a harder shaped article made of a resin composition is more brittle while a tougher article is less hard, that is, it is difficult that both strength/elastic modulus and toughness are satisfactory. In contrast, a shaped article from a resin composition of the present invention exhibits not only high strength and elastic modulus derived from the polymer (A) but also toughness given by the monomer (B). Furthermore, the monomer (B), which contains the compound (b1) represented by formula (1) in 70% by weight or more, can make polymethyl methacrylate swollen. Except methyl methacrylate, there have not been known a (meth)acrylate monomer which can make polymethyl methacrylate swollen. For example, according to our investigation, aliphatic straight-chain dimethacrylates such as 1,3-propylene glycol dimethacrylate or 1,10-decanediol dimethacrylate failed to swell polymethyl methacrylate. A content of the compound (b1) in the monomer (B) is suitably 80% by weight or more, more suitably 90% by weight or more, further suitably 95% by weight or more. If a content of the compound (b1) is less than 70% by weight, toughness of a shaped article formed is insufficient. The compound (b1) can be used alone or in combination of two or more.

R in formula (1) is a methyl group or a hydrogen atom. When R is a methyl group, the polymerizable group in both ends of the compound (b1) is a methacryloyl group, and when R is a hydrogen atom, the polymerizable group in both ends of the compound (b1) is an acryloyl group. The compound (b1) is a crosslinkable monomer having such a polymerizable group in both ends, and resin composition of the present invention is crosslinked by polymerization of the compound (b1) to give a cured shaped article. The compound (b1), which has two such intramolecular polymerizable groups, can make the polymer (A) swollen and give a shaped article exhibiting excellent toughness. For providing a shaped article with high strength and a high elastic modulus, R is suitably a methyl group. For providing a shaped article with excellent toughness, R is suitably a hydrogen atom.

In formula (1), n is 2 to 4. Here, “n” corresponds to the number of ethylene glycol units in the polyethylene glycol unit. With n of 2 to 4, a shaped article exhibiting excellent toughness can be provided. If n is less than 2, a shaped article is insufficiently tough. If n is 5 or more, a shaped article formed has reduced strength or a lower elastic modulus and a swelling rate of the polymer (A) decreases. Here, n is suitably 3 or less, particularly suitably 2. When n is 2, there can be provided a shaped articles in which strength and an elastic modulus and toughness are excellently well-balanced and a swelling rate of the polymer (A) increases.

The use of the monomer (B) of the present invention allows for providing a shaped article exhibiting high strength and a high elastic modulus as well as excellent toughness. Although its mechanism is not clearly understood, the following hypothesis can be inferred.

In a resin composition of the present invention, it can be assumed that the monomer (B) penetrates a web of molecular chains of the polymer (A) and then the monomer (B) is polymerized to form a so-called “semi-interpenetrating network structure” in which cross-linked structures formed by polymerizing the compound (b1) and the molecular chains of the polymer (A) are mutually entangled. Here, it can be assumed that a distance between crosslinking positions in the crosslinked structures after the polymerization is so proper that a shaped article formed is endowed with excellent toughness. In theory, a distance between crosslinking positions is proportional to a distance between the polymerizable groups in both ends of the compound (b1), and it can be, therefore, assumed that toughness of the shaped article significantly depends on a length of the polyethylene glycol unit in the compound (b1) represented by formula (1). Specifically, if n is less than 2, a distance between crosslinking positions is so small that a shaped article is too hard and thus brittle. If n is more than 5, a distance between crosslinking positions is so large that an article would be excessively soft.

The monomer (B) can contain additional monomers other than the compound (b1). There are no particular restrictions to such monomers as long as they are copolymerizable with the compound (b1). Examples include monofunctional (meth)acrylates such as methyl(meth)acrylate, ethyl (meth)acrylate, isopropyl (meth)acrylate, n-propyl (meth)acrylate, n-butyl (meth)acrylate, isobutyl (meth)acrylate, t-butyl (meth)acrylate, methoxydiethylene glycol (meth)acrylate, ethoxydiethylene glycol (meth)acrylate, 2,2,2-trifluoromethyl (meth)acrylate or 1H-1H-3H-tetrafluoropropyl (meth)acrylate; multifunctional (meth)acrylates such as propylene glycol di(meth)acrylate, 1,3-butanediol di(meth)acrylate, 1,4-butanediol di(meth)acrylate, 1,6-hexanediol di(meth)acrylate, 1,10-decanediol di(meth)acrylate, trimethylolpropane tri (meth)acrylate, trimethylolmethane tri(meth)acrylate, 1,6-octafluorohexanediol di(meth)acrylate or 1,2-tridecafluorononanediol di(meth)acrylate; vinyl carboxylates such as vinyl acetate; maleic anhydride; acrylonitrile; styrene; vinyl chloride; and olefins. A content of the monomers other than compound (b1) in the monomer (B) is generally 30% by weight or less, suitably 20% by weight, more suitably 10% by weight or less, further suitably 5% by weight or less.

There are no particular restrictions to the polymerization initiator (C) as long as it can polymerize the monomer (B), and a radical polymerization initiator, a photopolymerization initiator or the like can be used. As a radical polymerization initiator, an organic peroxide or an organic azo compound can be suitably used. Such a radical polymerization initiator can be selected from those generating radicals by heating or those generating radicals at an ambient temperature by mixing with a reducing agent such as an amine. When a photopolymerization initiator is used, a combination of a sensitizer and a reducing agent can be employed.

Examples of a polymerization initiator generating radicals by heating include benzoyl peroxide, 2,4-dichlorobenzoyl peroxide, m-tolyl peroxide, t-butyl peroxybenzoate, di-t-butyl peroxyisophthalate, 2,5-dimethyl-2,5-di(benzoylperoxy)hexane, 2,5-dimethyl-2,5-di[(o-benzoyl)benzoylperoxy]hexane, t-butyl peroxy-2-ethylhexanoate or t-butyl peroxyisopropyl carbonate.

For a combination of a peroxide with a reducing agent which generates radicals at an ambient temperature, examples of the peroxide include benzoyl peroxide, 2,4-dichlorobenzoyl peroxide, m-tolyl peroxide, t-butyl peroxybenzoate, di-t-butyl peroxyisophthalate, 2,5-dimethyl-2,5-di(benzoylperoxy) hexane, 2,5-dimethyl-2,5-di[(o-benzoyl)benzoylperoxy]hexane, t-butyl peroxy-2-ethylhexanoate or t-butyl peroxyisopropyl carbonate, and examples of a reducing agent include aromatic tertiary amines such as N,N-dimethylaniline, N,N-dimethyl-p-toluidine, N,N-dimethyl-m-toluidine, N,N-diethyl-p-toluidine, N,N-dimethyl-3,5-dimethylaniline, N,N-dimethyl-3,4-dimethylaniline, N,N-dimethyl-4-ethylaniline, N,N-dimethyl-4-i-propylaniline, N,N-dimethyl-4-t-propylaniline, N,N-dimethyl-3,5-di-t-butylaniline, N,N-bis(2-hydroxyethyl)-3,5-dimethylaniline, N,N-di(2-hydroxyethyl)-p-toluidine, N,N-bis(2-hydroxyethyl)-3,4-dimethylaniline, N,N-bis(2-hydroxyethyl)-4-i-propylaniline, N,N-bis(2-hydroxyethyl)-4-t-propylaniline, N,N-bis(2-hydroxyethyl)-3,5-di-1-propylaniline, N,N-bis(2-hydroxyethyl)-3,5-di-t-propylaniline, methyl 4-dimethylaminobenzoate, ethyl 4-dimethylaminobenzoate, n-butoxyethyl 4-dimethylaminobenzoate or (2-methacryloyloxy)ethyl 4-dimethylaminobenzoate; aliphatic tertiary amines such as trimethylamine, triethylamine, N-methyldiethanolamine, N-ethyldiethanolamine, N-n-butyldiethanolamine, N-lauryldiethanolamine, p-tolyldiethanolamine, (2-dimethylamino)ethyl methacrylate, N-methyldiethanolamine dimethacrylate, N-ethyldiethanolamine dimethacrylate, triethanolamine monomethacrylate, triethanolamine dimethacrylate and triethanolamine trimethacrylate; and sulfinic acids or salts thereof such as benzenesulfinic acid, sodium benzenesulfinate, potassium benzenesulfinate, calcium benzenesulfinate, lithium benzenesulfinate, toluenesulfinic acid, sodium toluenesulfinate, potassium toluenesulfinate, calcium toluenesulfinate, lithium toluenesulfinate, 2,4,6-trimethylbenzenesulfinic acid, sodium 2,4,6-trimethylbenzenesulfinate, potassium 2,4,6-trimethylbenzenesulfinate, potassium 2,4,6-trimethylbenzenesulfinate, lithium 2,4,6-trimethylbenzenesulfinate, 2,4,6-triethylbenzenesulfinic acid, potassium 2,4,6-triethylbenzenesulfinate, calcium 2,4,6-triethylbenzenesulfinate, 2,4,6-i-propylbenzenesulfinic acid, potassium 2,4,6-triisopropylbenzenesulfinate and calcium 2,4,6-triisopropylbenzenesulfinate.

In terms of a sensitizer and a reducing agent for a photopolymerization initiator, examples of a sensitizer include camphorquinone, benzil, diacetyl, benzyl dimethyl ketal, benzyl diethyl ketal, benzyl di(2-methoxyethyl) ketal, 4,4′-dimethylbenzyl-dimethyl ketal, anthraquinone, 1-chloroanthraquinone, 2-chloroanthraquinone, 1,2-benzanthraquinone, 1-hydroxyanthraquinone, 1-methylanthraquinone, 2-ethylanthraquinone, 1-bromoanthraquinone, thioxanthone, 2-isopropylthioxanthone, 2-nitrothioxanthone, 2-methylthioxanthone, 2,4-dimethylthioxanthone, 2,4-diethylthioxanthone, 2,4-diisopropylthioxanthone, 2-chloro-7-trifluoromethylthioxanthone, thioxanthone-10,10-dioxide, thioxanthone-10-oxide, benzoin methyl ether, benzoin ethyl ether, benzoin isopropyl ether, benzoin isobutyl ether, benzophenone, bis(4-dimethylaminophenyl) ketone, 4,4′-bisdiethyl aminobenzophenone, 2,4,6-trimethylbenzoyldiphenylphosphine oxide, 2,6-dimethoxybenzoyldiphenylphosphine oxide, 2,6-dichlorobenzoyldiphenylphosphine oxide, 2,3,5,6-tetramethylbenzoylphenylphosphine oxide, benzoyl di-(2,6-dimethylphenyl)phosphonate, 2,4,6-trimethylbenzoylethoxyphenylphosphine oxide, 3,3′-carbonyl bis(7-diethylamino)coumarin, 3-(4-methoxybenzoyl) coumarin, 2,4,6-tris(trichloromethyl)-s-triazine, 2,4,6-tris(tribromomethyl)-s-triazine or 2-methyl-4,6-bis(trichloromethyl)-s-triazine, and examples of a reducing agent include tertiary amines such as methyl 4-dimethylaminobenzoate, ethyl 4-dimethylaminobenzoate, 2-dimethylaminoethyl methacrylate, N,N-bis{(meth)acryloyloxyethyl}-N-methylamine and N-methyldiethanolamine, 4-dimethylaminobenzophenone; aldehydes such as dimethylaminobenzaldehyde and terephthalaldehyde; thiol-containing compounds such as 2-mercaptobenzoxazole, decane thiol, 3-mercaptopropyltrimethoxysilane and thiobenzoic acid; and sulfinic acids or salts thereof such as benzenesulfinic acid, sodium benzenesulfinate, potassium benzenesulfinate, calcium benzenesulfinate, lithium benzenesulfinate, toluenesulfinic acid, sodium toluenesulfinate, potassium toluenesulfinate, calcium toluenesulfinate, lithium toluenesulfinate, 2,4,6-trimethylbenzenesulfinic acid, sodium 2,4,6-trimethylbenzenesulfinate, potassium 2,4,6-trimethylbenzenesulfinate, potassium 2,4,6-trimethylbenzenesulfinate, lithium 2,4,6-trimethylbenzenesulfinate, 2,4,6-triethylbenzenesulfinic acid, potassium 2,4,6-triethylbenzenesulfinate, calcium 2,4,6-triethylbenzenesulfinate, 2,4,6-i-propylbenzenesulfinic acid, potassium 2,4,6-triisopropylbenzenesulfinate and calcium 2,4,6-triisopropylbenzenesulfinate.

A resin composition of the present invention suitably contains 30 to 100 parts by weight of the monomer (B) based on 100 parts by weight of the polymer (A). If a content of the monomer (B) is less than 30 parts by weight, a powder of the polymer (A) may not be sufficiently swollen to form a homogeneous dough. A content of the monomer (B) is more suitably 35 parts by weight or more, further suitably 40 parts by weight or more, particularly suitably 46 parts by weight or more. If a content of the monomer (B) is more than 100 parts by weight based on 100 parts by weight of the polymer (A), a shaped article formed may have deteriorated mechanical strength and an increased polymerization shrinkage. A content of the monomer (B) is more suitably 80 parts by weight or less, further suitably 70 parts by weight or less, particularly suitably 65 parts by weight or less. In the light of mechanical strength of a shaped article formed, a lesser content of the monomer (B) is preferable within the range where a powder of the polymer (A) can be sufficiently swollen.

A content of the polymerization initiator (C) is generally 0.01 to 10 parts by weight based on 100 parts by weight of the monomer (B). If a content of the polymerization initiator (C) is less than 0.01 parts by weight based on 100 parts by weight of the monomer (B), it may be inadequately effective for promoting a polymerization reaction. The content is suitably 0.1 parts by weight or more. If a content of the polymerization initiator (C) is more than 10 parts by weight based on 100 parts by weight of the monomer (B), its effect for promoting a polymerization reaction may reach a plateau and eluted compositions derived from the polymerization initiator (C) may be increased. The content is suitably 5 parts by weight or less.

A resin composition of the present invention can contain other components in addition to the polymer (A), the monomer (B) and the polymerization initiator (C). For example, the composition can contain, for example, a filler, a colorant, an antimicrobial and a perfume, depending on its application.

In a suitable process for manufacturing a resin composition of the present invention, a powder of the polymer (A) and a liquid of the monomer (B) are blended in the presence of the polymerization initiator (C) to increase a viscosity. After the blending, the resin composition changes from a highly viscous liquid to a dough form. When it is desired to prevent entrainment of bubbles into the resin composition during blending the powder and the liquid, preferably the powder is dispersed in the liquid or impregnated with the liquid, and then the mixture is allowed to stand without stirring to increase a viscosity. However, for rapid increase in a viscosity or overall homogeneity, the mixture is preferably stirred.

Once a powder of the polymer (A) and a liquid of the monomer (B) are blended, particles of the polymer (A) constituting the powder are gradually impregnated with the monomer (B), resulting in swelling of the particles. When the resin composition is in a dough state, the particles impregnated with the monomer (B) is softened such that it can be easily deformed by a stress during shaping. Here, it is believed that the particles would be impregnated with plenty of the monomer (B) around their surfaces to make the particles swollen. As described above, the particles of the polymer (A) would be swollen with the monomer (B).

Meanwhile, once a powder of the polymer (A) and a liquid of the monomer (B) are blended, voids in the powder of the polymer (A) are filled with the liquid of the monomer (B). When the resin composition is in a dough state, it can be regarded that the polymer (A) is dissolved in the monomer (B).

As described above, the resin composition as a dough obtained by blending a powder of the polymer (A) and a liquid of the monomer (B) consists of particles of the polymer (A) swollen by impregnation with the monomer (B) and a monomer (B) solution in which the polymer (A) dissolves. And, the monomer (B) solution fills the voids between the particles of the polymer (A).

When such a resin composition as a dough is polymerized, the compound (b1) in the monomer (B) impregnated in the particles of the polymer (A) would be crosslinked in regions derived from the particles of the polymer (A) to form a “semi-interpenetrating network structure” as described above. It would contribute to give a shaped article formed which has high strength and a high elastic modulus while exhibiting excellent toughness. In the light of mechanical strength of a shaped article formed, the amount of the liquid of the monomer (B) is preferably lower within the range where the liquid can sufficiently swell the powder of the polymer (A). Thus, a proportion of regions derived from the particles of the polymer (A) in a shaped article formed is large, so that strength, an elastic modulus and toughness are further improved.

An average particle size of the powder of the polymer (A) is generally, but not limited to, 2 to 200 μm. If the average particle size is less than 2 μm, the powder may not be evenly dispersed when the powder of the polymer (A) and the liquid of the monomer (B) are blended. The average particle size is suitably 10 μm or more, further suitably 20 μm or more. If the average particle size of the polymer (A) is more than 200 μm, the powder may be too slowly swollen. The average particle size is suitably 150 μm or less, further suitably 100 μm or less.

There are no particular restrictions to a method for blending the polymerization initiator (C). The polymerization initiator (C) can be preliminarily mixed with at least one of the powder of the polymer (A) and the liquid of the monomer (B), or alternatively can be added when a resin composition is prepared. Preferably the polymerization initiator (C) is preliminarily contained in at least one of the powder of the polymer (A) and the liquid of the monomer (B) in the light of convenient operation.

It is preferable that the polymer (A) preliminarily contains the polymerization initiator (C). That is, particles of the polymer (A) constituting the powder contain the polymerization initiator (C). In such a case, a polymerization initiator added in preparation of the polymer (A) by, for example, suspension polymerization can be used as it is. Alternatively, when the polymerization initiator (C) is of a type of generating radicals by mixing two or more compounds, one compound and the other compound can be preliminarily contained in the polymer (A) and the monomer (B), respectively.

Once the powder of the polymer (A) and the liquid of the monomer (B) are blended, the polymer (A) is impregnated with the monomer (B) and the polymer (A) is swollen so that a viscosity gradually increase to form a dough. Preferably, after such increase in a viscosity, the composition is shaped to provide a shaped article. The resin composition to be shaped is preferably in a dough state with an adequately increased viscosity while maintaining fluidity. Shaping can be conducted by filling a mold with the composition, pressing the composition against the mold, shaping the composition by hand or the like. In the use of a resin composition for a material for a denture base and the like, a resin composition even as a high viscosity liquid with high viscoelasticity can be used when the composition is processed on a model. In this case, shortly after the powder and the liquid are blended, the mixture can be used.

After the powder of polymer (A) and the liquid of the monomer (B) are blended in the presence of the polymerization initiator (C), a time taken for the resin composition to become a dough is regulated, depending on its application. The shorter the polyethylene glycol unit in the compound (b1) represented by formula (1) is, the shorter a time taken for making the resin composition a dough is. If “n” is 3 or 4, a time taken for making the resin composition a dough may be several days. Thus, “n” is suitably 3 or less, particularly suitably 2.

There are no particular restrictions to a time taken for making a resin composition a stable dough after the powder of the polymer (A) and the liquid of the monomer (B) are blended in the presence of the polymerization initiator (C), but it is preferable that a time required for a process such as shaping the resin composition is ensured. When the monomer (B) of the present invention is used as a liquid, the resin composition is kept in a dough state for a time adequate for the process in contrast to the case where methyl methacrylate is used.

After shaping, the resin composition of the present invention can be polymerized to give a cured shaped article. When the polymerization initiator (C) which initiates a polymerization reaction at room temperature is used, just blending can trigger the polymerization reaction at the same time as increase in a viscosity. When a polymerization reaction proceeds by heating or light irradiation, it is often that the polymerization reaction substantially never proceeds before heating or light irradiation. After shaping the resin composition, the polymerization reaction can proceed by heating or light irradiation. And, heating is suitable in the light of processability. For example, the polymerization reaction can easily proceed only by immersing the article in hot water. Since hardness of the resin composition can be increased by changing a polymerization degree by adjusting the polymerization conditions such as a polymerization temperature and a polymerization time, a shaped article having desired hardness can be easily obtained.

A resin composition as a dough prepared by blending the powder of the polymer (A) and the liquid of the monomer (B) in the presence of the polymerization initiator (C) consists of particles of the polymer (A) swollen by impregnation with the monomer (B) and a solution of the polymer (A) in the monomer (B) which fills inter-particle voids. When such a resin composition as a dough is polymerized, particles constituting the powder of the polymer (A) substantially keeps its shape after polymerization. Voids in particulate regions derived from such particles of the polymer (A) are filled with a cured material produced by polymerization of the monomer (B). Thus, it is suitable that a shaped article produced by polymerization consists of particulate regions derived from particles of the polymer (A) and regions derived from the monomer (B) which fill the voids. Thus, the shaped article is further improved in strength, an elastic modulus and toughness. In a shaped article, a shape of a region derived from particles of the polymer (A) can be a sphere or a distorted form. A pressure during shaping may cause distortion in a shape of a region derived from particles of the polymer (A).

It is preferable that a proportion of the regions derived from particles of the polymer (A) in a shaped article is as large as possible. Thus, a shaped article becomes more excellent in strength, an elastic modulus and toughness. It can be speculated that the article has a structure where regions derived from particles of the polymer (A) having a “semi-interpenetrating network structure” are mutually close so that strength, an elastic modulus and toughness are improved. A structure of the shaped article consisting of regions derived from particles of the polymer (A) and regions derived from the liquid of the monomer (B) can be confirmed by, for example, observing a thin section prepared by slicing the shaped article by optical microscopy.

A medical resin composition of the present invention is suitably used as a dental resin composition. Specifically, a suitable embodiment is a denture base or mouthpiece formed by curing the resin composition. A denture is generally produced as follows. An impression in patient's oral cavity is taken and a plaster model is formed based on the impression. Then, a wax denture base is formed on the plaster model and artificial teeth are placed into the wax denture base to form a wax denture. Then, the wax denture is invested in an investing material in a flask to take a model of the wax denture. Then, the wax is removed, for example, with hot water, to form voids of the denture base in the investing material in the flask. The voids are filled with a resin composition in a dough state which is then cured. Then, the cured product is removed from the investing material and processed by shape modification and polishing in the final stage to give a finished product. A mouthpiece is produced substantially as is for producing a denture except for placing artificial teeth. A shaped article formed by polymerizing a resin composition of the present invention exhibits high strength, a high elastic modulus and excellent toughness, so that it is adequately strong even with a small thickness and breakage due to an occlusal pressure, impact or the like can be prevented. Furthermore, it is believed that the monomer (B) is less leachable and safer to a living body than methyl methacrylate. Furthermore, since a denture or mouthpiece has a lower polymerization shrinkage than that produced using methyl methacrylate as a monomer, it exhibits good dimensional adaptability with a mucous membrane surface in patient's oral.

A medical resin composition of the present invention can be also suitably used as a bone cement. It can be speculated that a resin composition of the present invention is suitable for such an application because the monomer (B) is less leachable and thus safer to a living body than methyl methacrylate and heat production and shrinkage during polymerization are probably smaller in comparison with a composition containing methyl methacrylate as a monomer.

A medical kit comprising a powder of a polymer (A) comprising 70% by weight or more of methyl methacrylate units; and a liquid of a monomer (B) comprising 70% by weight or more of compound (b1) represented by formula (1):

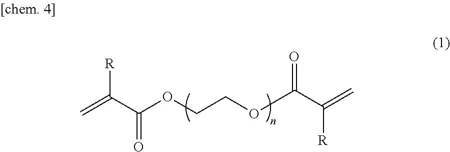

wherein R denotes a methyl group or a hydrogen atom, and n is an integer of 2 to 4, wherein at least one of the powder and the liquid comprises a polymerization initiator (C), is also a suitable embodiment of the present invention. In such a medical kit, a resin composition can be prepared by a simple procedure of just blending two components: the powder and the liquid. The polymerization initiator (C) can be incorporated in the powder or the liquid as described for a preparation method for a resin composition.

### EXAMPLES

There will be described the present invention with reference to Examples. Test pieces in Examples were prepared and measured in a laboratory at 23° C. and a humidity of 50%. Monomers described below were used in Examples.

### Monomer

Ethylene glycol dimethacrylate [1G, n=1, specific gravity: 1.05 g/mL (at 23° C.)]
Diethylene glycol dimethacrylate [2G, n=2, specific gravity: 1.07 g/mL (at 23° C.)]
Triethylene glycol dimethacrylate [3G, n=3, specific gravity: 1.07 g/mL (at 23° C.)]
Tetraethylene glycol dimethacrylate [4G, n=4, specific gravity: 1.08 g/mL (at 23° C.)]
Diethylene glycol diacrylate [DEGDA, n=2, specific gravity: 1.12 g/mL (at 23° C.)]

### Example 1

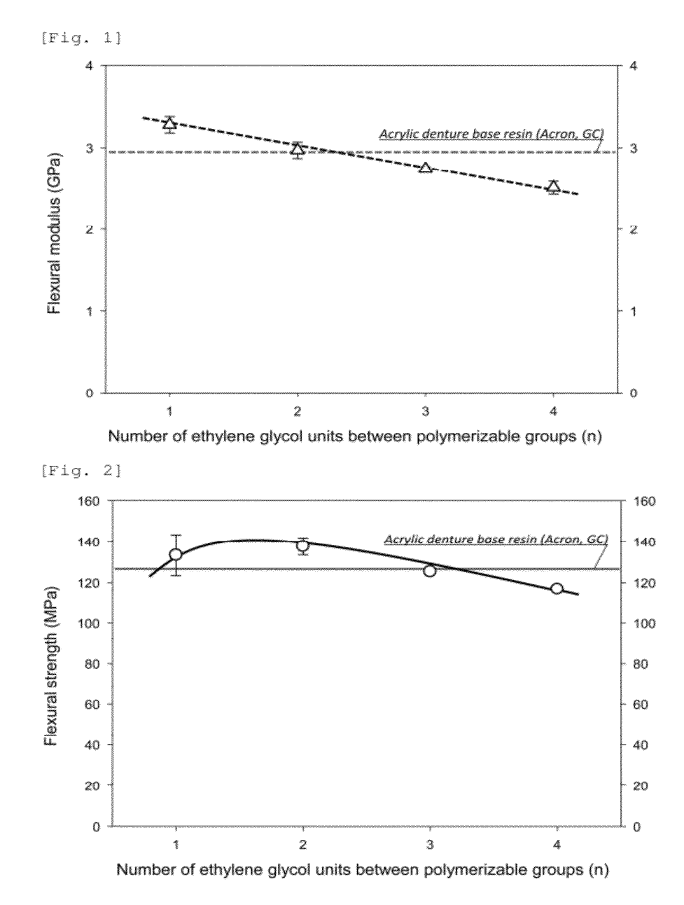

Four grams of a powder of polymethyl methacrylate produced by suspension polymerization (Negami Chemical Industrial Co., Ltd., “Hi-Pearl D-100M”: weight-average molecular weight: 500,000, average particle size: about 50 to 80 μm, containing 0.5 to 1.0% by weight of benzoyl peroxide) and 2 mL of a liquid of diethylene glycol dimethacrylate (hereinafter, sometimes simply referred as to “2G”) were mixed and allowed to stand. After about 24 hours, the mixture which had become a dough was charged in a Teflon® mold for shaping a 2 mm×2 mm×25 mm test piece, clamped and heated in a thermostat chamber (ESPEC Corp., “ST-101B1”) at 65° C. for 60 min and then at 100° C. for 90 min to promote polymerization. After it was allowed to cool, the test piece removed from the Teflon® mold was allowed to stand in the air one day, and was then subjected to a three-point bending test (fulcrum distance: 20 mm, crosshead speed: 0.5 mm/min) using a universal testing machine (Instron 5544) to determine a flexural modulus, a flexural strength, a maximum deflection and a fracture energy. The results of determination of four flexural properties are shown in Table 1 and FIGS. 1 to 4.

### Examples 2 and 3

A liquid and a powder were mixed and allowed to stand as described in Example 1, substituting triethylene glycol dimethacrylate (hereinafter, sometimes simply referred to as “3G”) or tetraethylene glycol dimethacrylate (hereinafter, sometimes simply referred to as “4G”) for 2G as a liquid. A mixture which had become a dough was obtained after about 48 hours or about 96 hours for 3G or 4G as the liquid, respectively. Using the mixture, a test piece was produced as described in Example 1 and subjected to a three-point bending test using a universal testing machine. For each test piece, the results of determination of four flexural properties are shown in Table 1 and FIGS. 1 to 4.

### Comparative Example 1

A liquid and a powder were mixed and allowed to stand as described in Example 1, substituting ethylene glycol dimethacrylate (hereinafter, sometimes simply referred to as “1G”) for 2G as a liquid. A mixture which had become a dough was obtained after about 20 hours. Using the mixture, a test piece was produced as described in Example 1 and subjected to a three-point bending test using a universal testing machine. For each test piece, the results of determination of four flexural properties are shown in Table 1 and FIGS. 1 to 4.

### Comparative Example 2

Using a commercially available acrylic resin for a denture base “Acron” (GC Company), a test piece with a size of 2 mm×2 mm×25 mm was produced in accordance with the instructions, and was subjected to a three-point bending test by a universal testing machine. The results of determination of four flexural properties are shown in Table 1. As comparison data, measured values are shown FIGS. 1 to 4.

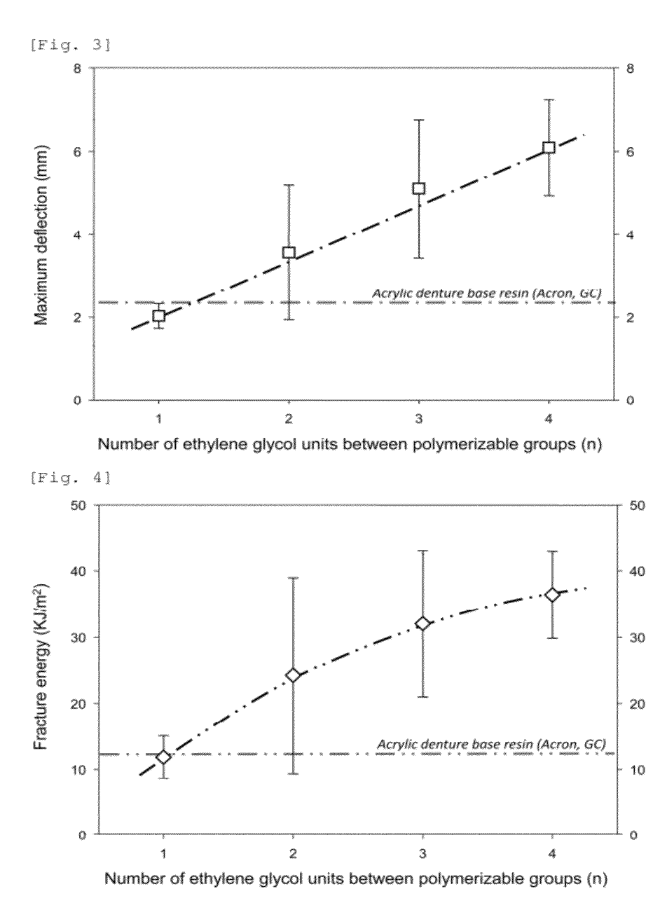

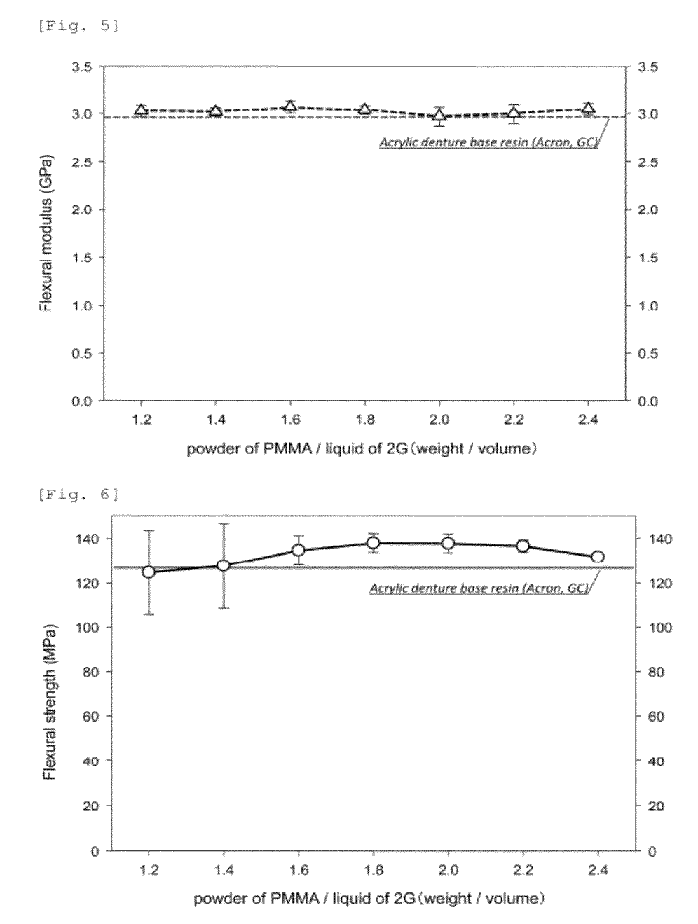

FIGS. 1 to 4 show relationship between a length of the polyethylene glycol unit in the compound (b1) represented by formula (1) and mechanical properties of a shaped article formed. As shown in FIG. 1, the shorter the polyethylene glycol unit in the compound (b1) is, the higher a flexural modulus of the shaped article formed is. As shown in FIG. 2, flexural strength was surprisingly highest in a shaped article produced for 2G rather than a shaped article for 1G in which the polyethylene glycol unit was shortest. As shown in FIGS. 3 and 4, as the polyethylene glycol unit was longer, a maximum deflection and a fracture energy in a shaped article formed were significantly improved. The shaped article formed for 2G had a flexural modulus and flexural strength higher than those for the commercially available acrylic resin (Comparative Example 2). The shaped articles for 3G and 4G had a flexural modulus and a flexural strength slightly lower than those for the commercially available acrylic resin (Comparative Example 2). All of the shaped articles formed for 2G, 3G and 4G had maximum deflection and fracture energy significantly higher than those for the commercially available acrylic resin (Comparative Example 2). The shaped article formed for 2G had the best balance between strength or elastic modulus and toughness.

### Example 4

A liquid and a powder were mixed and allowed to stand as described in Example 1, substituting diethylene glycol diacrylate (hereinafter, sometimes simply referred to as “DEGDA”) for 2G as a liquid. A mixture which had become a dough was obtained after about 12 hours. Using the mixture, a test piece was produced as described in Example 1 and subjected to a three-point bending test using a universal testing machine. DEGDA has a structure where methacryloyl groups in both ends of 2G are replaced by acryloyl groups. The measurement results are shown Table 1. The shaped article formed had a flexural strength and a flexural modulus slightly lower than those for the shaped article formed for 2G as the compound (b1) while having a maximum deflection and a fracture energy higher than those for the shaped article formed for 2G.

### Comparative Examples 3 and 4

Four grams of a powder of an equimolar copolymer of methyl methacrylate and ethyl methacrylate produced by suspension polymerization (Negami Chemical Industrial Co., Ltd., “Hi-Pearl D-200”: weight-average molecular weight: 500,000, average particle size: about 70 to 90 μm, containing 0.5 to 1.0% by weight of benzoyl peroxide) and 2 mL of a liquid of 1G (Comparative Example 3) or 2G (Comparative Example 3) were mixed and allowed to stand. A mixture which had become a dough was obtained after about 0.5 hours or about 1 hour for 1G or 2G as the liquid, respectively. Using the mixture, a test piece was produced as described in Example 1 and subjected to a three-point bending test using a universal testing machine. For each test piece, the results of determination of four flexural properties are shown in Table 1. For the test piece produced using the equimolar copolymer of methyl methacrylate and ethyl methacrylate as the polymer polymer, a maximum deflection and a fracture energy were significantly low whether the liquid was 1G or 2G. A flexural strength was also significantly low.

### Comparative Example 5

Four grams of a powder of polymethyl methacrylate produced by suspension polymerization (Negami Chemical Industrial Co., Ltd., “Hi-Pearl D-100M”: weight-average molecular weight: 500,000, average particle size: about 50 to 80 μm, containing 0.5 to 1.0% by weight of benzoyl peroxide) and 2 mL of a liquid of an equimolar mixture of 1G and 3G were mixed and allowed to stand. Using the mixture which had become a dough after about 22 hours, a test piece was produced as described in Example 1, and subjected to a three-point bending test using a universal testing machine. For each test piece, the measurement results of four flexural properties are shown in Table 1. The test piece produced using the equimolar mixture of 1G and 3G as the liquid had a maximum deflection and a fracture energy significantly lower than those for the shaped article using 3G alone as the liquid (Example 2).

TABLE 1

| | | | Flexural | Flexural | Maximum | Fracture |
|---|---|---|---|---|---|---|
| | | | modulus | strength | deflection | energy |
| | Liquid | Powder | (GPa) | (MPa) | (mm) | (KJ/m²) |
| Example 1 | 2G | PMMA | 2.97 ± 0.10 | 137.6 ± 4.2 | 3.56 ± 1.62 | 24.2 ± 14.8 |
| Example 2 | 3G | PMMA | 2.74 ± 0.03 | 125.3 ± 1.1 | 5.10 ± 1.67 | 32.0 ± 11.1 |
| Example 3 | 4G | PMMA | 2.51 ± 0.08 | 116.6 ± 1.3 | 6.09 ± 1.16 | 36.4 ± 6.6 |
| Example 4 | DEGDA | PMMA | 2.83 ± 0.03 | 129.5 ± 0.6 | 4.86 ± 1.07 | 29.9 ± 7.5 |
| Comparative | 1G | PMMA | 3.28 ± 0.10 | 133.3 ± 10.0 | 2.03 ± 0.30 | 11.8 ± 3.3 |
| Example 1 | | | | | | |
| Comparative | MMA*¹ | PMMA*¹ | 2.96 ± 0.11 | 127.8 ± 3.3 | 2.35 ± 0.26 | 12.2 ± 1.6 |
| Example 2 | | | | | | |
| Comparative | 1G | Poly | 2.89 ± 0.05 | 62.3 ± 7.5 | 0.82 ± 0.12 | 1.7 ± 0.6 |
| Example 3 | | (MMA-EMA) | | | | |
| Comparative | 2G | Poly | 2.69 ± 0.05 | 78.2 ± 10.1 | 1.23 ± 0.21 | 3.5 ± 1.3 |
| Example 4 | | (MMA-EMA) | | | | |
| Comparative | 1G/3G | PMMA | 2.99 ± 0.05 | 123.0 ± 7.3 | 2.01 ± 0.23 | 9.8 ± 1.9 |
| Example 5 | (=1/1) | | | | | |

Powder/liquid ratio = 2.0, Polymerization conditions: 65° C./60 min + 100° C./90 min
*¹Commercially available acrylic resin denture base: Acron (GC)

### Example 5

We investigated influence of a powder/liquid ratio in a resin composition of the present invention (powder-liquid ratio) on mechanical properties of a shaped article formed by polymerization. A powder of polymethyl methacrylate produced by suspension polymerization (Negami Chemical Industrial Co., Ltd., “Hi-Pearl D-100M”: weight-average molecular weight: 500,000, average particle size: about 50 to 80 μm, containing 0.5 to 1.0% by weight of benzoyl peroxide) and a liquid of 2G were mixed in the range of a powder-liquid ratio [powder (g)/liquid (mL)]=1.2 to 2.4 at 0.2 intervals and then allowed to stand [standing time (powder-liquid ratio): about 30 hours (1.2), about 30 hours (1.4), about 30 hours (1.6), about 24 hours (1.8), about 24 hours (2.0), about 24 hours (2.2), about 24 hours (2.4)]. Each test piece was prepared as described in Example 1 using a mixture which had become a dough, and subjected to a three-point flexural test using a universal testing machine. FIGS. 5 to 8 are graphs showing the measured values where a powder-liquid ratio and one of the four flexural properties are plotted on the horizontal and the vertical axes, respectively. Each graph also shows the measurement results for a commercially available acrylic resin for a denture base described in Comparative Example 2 as comparison data.

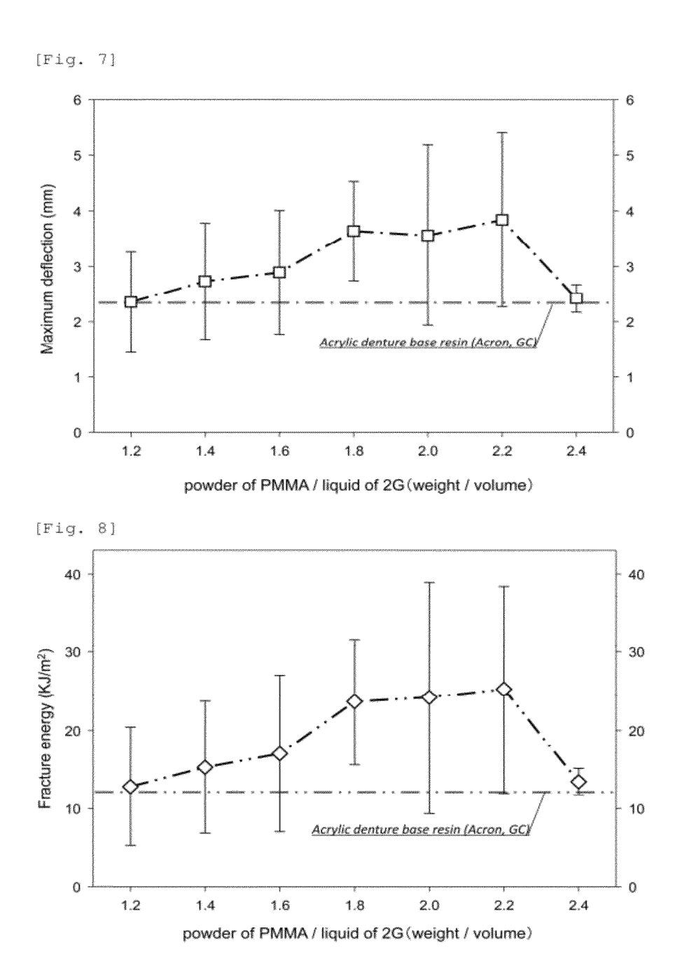

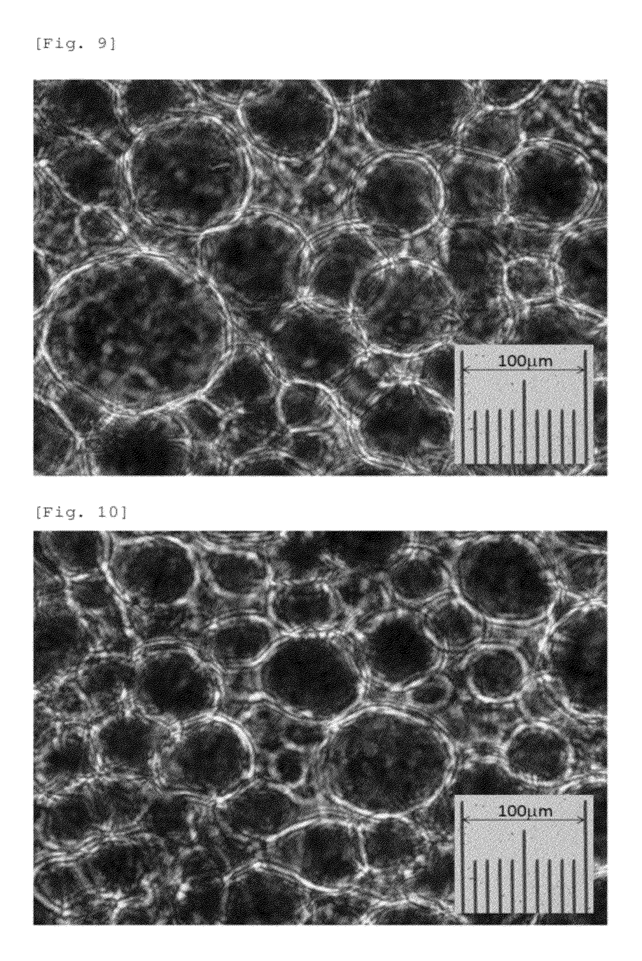

As shown in FIG. 5, a flexural modulus is higher in a shaped article produced by polymerizing a resin composition of the present invention at any powder-liquid ratio (1.2 to 2.4) investigated than “Acron”. As shown in FIG. 6, a flexural strength is higher in the range of a powder-liquid ratio of 1.4 to 2.4 g/mL for a resin composition of the present invention than “Acron” which is a commercially available resin for a denture base. As shown in FIGS. 7 and 8, both maximum deflection and fracture energy are higher in a shaped article produced by polymerizing a resin composition of the present invention at any powder-liquid ratio investigated than “Acron”; in particular, higher in the range of a powder-liquid ratio of 1.8 to 2.2 g/mL.

### Example 6

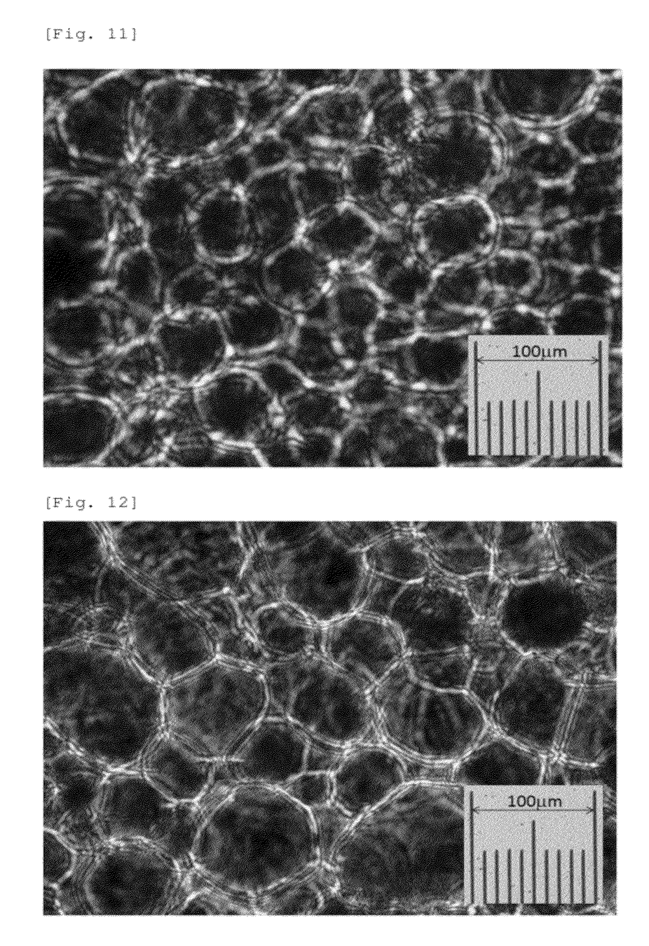

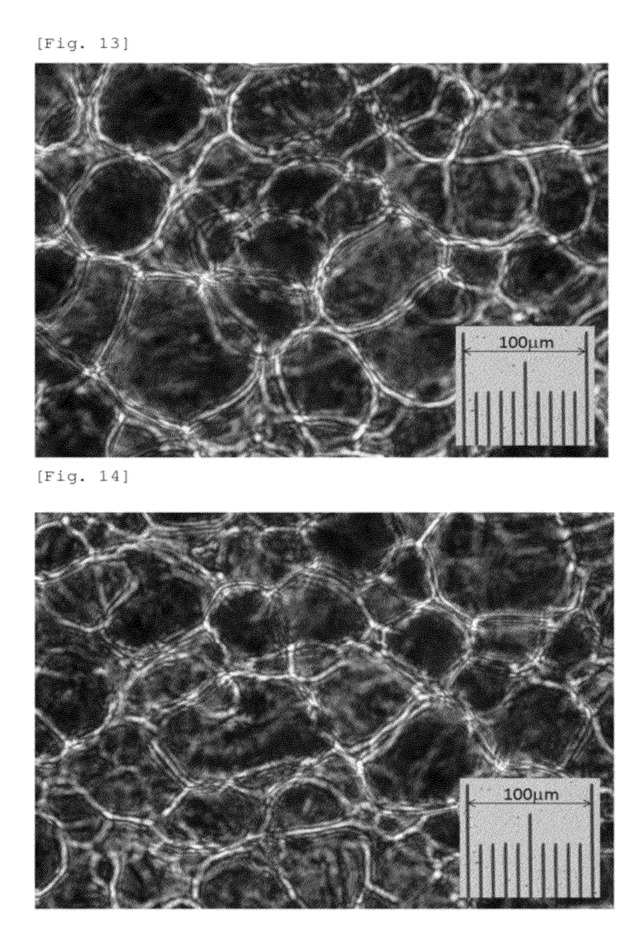

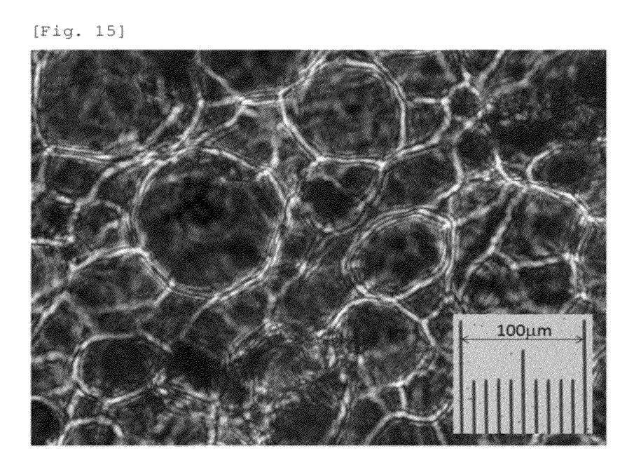

We investigated influence of a powder/liquid ratio in a resin composition of the present invention (powder-liquid ratio) on an architecture of a shaped article formed by polymerization. A powder of polymethyl methacrylate particles containing a pigment (dark pink) [powder of “Acron” from GC Inc. (corresponding standard: JIS T6501 “acrylic resin for a denture base (Class 1)”)] and a liquid of 2G were mixed in the range of a powder-liquid ratio [powder (g)/liquid (mL)]=1.2 to 2.4 at 0.2 intervals and allowed to stand [standing time (powder-liquid ratio): about 30 hours (1.2), about 30 hours (1.4), about 30 hours (1.6), about 24 hours (1.8), about 24 hours (2.0), about 24 hours (2.2), about 24 hours (2.4)]. Using a mixture which had become a dough, a 2 mm×2 mm×25 mm test piece with a size of was produced under the polymerization conditions as described in Example 1. The test piece was cut into a 2 mm×2 mm×10 mm sample, which was then placed in a silicon embedding plate for microtome, embedded with an epoxy resin (Epofix cold mounting resin, Struers A/S) and cured over 24 hours. The test piece embedded with the epoxy resin was cut by a glass knife (45°) using a microtome (ULTRACUT E, Leica Camera AG) to obtain a thin section with a thickness of about 5 μm. The thin section sample was observed by a light microscope (Olympus Corporation, “BX51”) with a transmitted light under the condition of 200 magnifications (object lens: 20 magnifications, eyepiece lens: 10 magnifications) while photos of the thin section were taken by a digital camera (Canon PowerShot S95) installed on the eyepiece lens. FIGS. 9 to 15 show a microscopic image of a thin section of a shaped article formed at each powder-liquid ratio [Figure numbers (powder-liquid ratio): FIG. 9 (1.2), FIG. 10 (1.4), FIG. 11 (1.6), FIG. 12 (1.8), FIG. 13 (2.0), FIG. 14 (2.2), FIG. 15 (2.4)].

FIG. 9 shows a photograph for the shaped article with the least amount of the powder (a powder-liquid ratio is 1.2 g/mL). In FIG. 9, a plurality of black circles are observed. The circles are black due to the pigment contained in polymethyl methacrylate, indicating that the circles are derived from particles of polymethyl methacrylate. In contrast, void regions between the circles are white, indicating light permeation. It is, therefore, indicated that the regions are derived from a liquid (2G) free from a pigment.

When the amount of a powder is low, that is, a powder-liquid ratio is from 1.2 to 1.6 g/mL (FIGS. 9 to 11), black regions derived from particles of polymethyl methacrylate have a shape of substantially circle, and regions derived from the liquid (2G) where a light permeates have a relatively larger area. On the other hand, when the amount of a powder is increased, that is, a powder-liquid ratio is from 1.8 to 2.2 g/mL (FIGS. 12 to 14), black regions derived from particles of polymethyl methacrylate is distorted rather than circular, and regions derived from particles of polymethyl methacrylate are substantially in contact with each other while light-permeating regions derived from the liquid (2G) have a very small area. When the amount of a powder is further increased, that is, a powder-liquid ratio is 2.4 g/mL (FIG. 15), regions derived from particles of polymethyl methacrylate with a distorted shape and substantially circular regions are observed while regions derived from the liquid (2G) have a very small area.

1. A medical resin composition comprising a polymer (A), a monomer (B) and a polymerization initiator (C), wherein
the polymer (A) comprises 70% by weight or more of methyl methacrylate units, and
the monomer (B) comprises 70% by weight or more of a compound (b1) represented by formula (1): 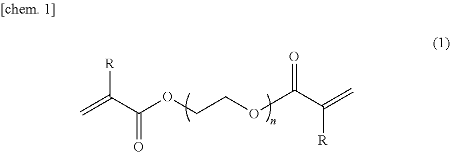
wherein R denotes a methyl group or a hydrogen atom and n is 2, and
the medical resin composition comprises 46 to 65 parts by weight of the monomer (B) based on 100 parts by weight of the polymer (A).

2. (canceled)

3. A dental resin composition consisting of the medical resin composition as claimed in claim 1.

4. A denture base or mouthpiece produced by curing the dental resin composition as claimed in claim 3.

5. A bone cement consisting of the medical resin composition as claimed in claim 1.

6. A process for manufacturing the medical resin composition as claimed in claim 1, comprising mixing a powder of the polymer (A) and a liquid of the monomer (B) in the presence of the polymerization initiator (C) to increase a viscosity.

7. The process for manufacturing a medical resin composition as claimed in claim 6, wherein the polymer (A) preliminarily comprises the polymerization initiator (C).

8. A medical kit comprising a powder of a polymer (A) comprising 70% by weight or more of methyl methacrylate units; and a liquid of a monomer (B) comprising 70% by weight or more of compound (b1) represented by formula (1): 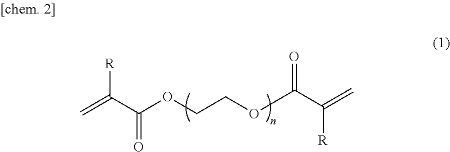
wherein R denotes a methyl group or a hydrogen atom, and n is 2, wherein
at least one of the powder and the liquid comprises a polymerization initiator (C), and
an amount of the monomer (B) is 46 to 65 parts by weight based on 100 parts by weight of the polymer (A).
